(19) United States
(12) Patent Application Publication
(10) Pub. No.: US 2026/0058446 A1
(43) Pub. Date: Feb. 26, 2026

(54) Combination Hand Tool

(71) Applicant: Milwaukee Electric Tool Corporation, Brookfield, WI (US)

(72) Inventors: Jack C. Melkovitz, Wauwatosa, WI (US); Matthew A. Lownik, Wauwatosa, WI (US)

(21) Appl. No.: 19/317,844

(22) Filed: Sep. 3, 2025

Related U.S. Application Data
(63) Continuation of application No. PCT/US2025/042575, filed on Aug. 19, 2025.
(60) Provisional application No. 63/684,981, filed on Aug. 20, 2024.

(51) Int. Cl. H02G 1/12; B25B 7/22

(52) U.S. Cl. CPC H02G 1/1214; B25B 7/22

(57) ABSTRACT

Various embodiments of a combination hand tool such as a wire stripper are provided. The wire stripper includes first jaw portion and a second jaw portion having a plurality of stripper apertures. In a specific embodiment, the first jaw and second jaw have a spring constant between 450 N/mm and 550 N/mm, measured when a force is applied in a direction parallel to the pivot axis to an associated jaw tip with a pivot member being held. In various embodiments the first jaw and/or the second jaw have a cutting recess. In such embodiments, the first and second jaws have a first hardness and the cutting recess has a second hardness that is greater than the first hardness.

### CROSS-REFERENCE TO RELATED PATENT APPLICATIONS

The present application is a continuation of International Application No. PCT/US2025/042575, filed on Aug. 19, 2025, which claims the benefit of and priority to U.S. Provisional Application No. 63/684,981, filed on Aug. 20, 2024, which is incorporated herein by reference in its entirety.

### BACKGROUND OF THE INVENTION

The present invention relates generally to the field of hand tools and in particular combination hand tools. The present invention relates specifically to a combination hand tool such as a wire stripper, combination pliers, etc.

### SUMMARY OF THE INVENTION

One embodiment of the invention relates to a hand tool. The hand tool includes a first jaw and a second jaw. The first jaw includes a first tip portion and a first plurality of apertures. The second jaw includes a second tip portion and a second plurality of apertures. A pivot pin couples the first jaw to the second jaw for movement of the first jaw and the second jaw about a pivot axis. The hand tool further includes a first handle coupled to the first jaw and a second handle coupled to the second jaw. A cutting recess is defined in at least one of the first jaw and the second jaw. The cutting recess is aligned with the pivot pin in a longitudinal direction. The first jaw and the second jaw are separate, non-integrally formed with the first handle and the second handle.

Another embodiment of the invention relates to a wire stripper. The wire stripper includes a first jaw and a second jaw. The first jaw includes a first tip portion and a first plurality of apertures, each of the first plurality of apertures includes a first angled edge and a second angled edge. The second jaw includes a second tip portion and a second plurality of apertures. A pivot pin couples the first jaw to the second jaw for movement of the first jaw and the second jaw about a pivot axis. The hand tool further includes a first handle coupled to the first jaw and a second handle coupled to the second jaw. The first jaw and the second jaw are separate, non-integrally formed with the first handle and the second handle.

Another embodiment of the invention relates to a hand tool. The hand tool includes a first jaw and a second jaw. The first jaw includes a first tip portion, a first beveled edge, and a first plurality of apertures positioned between the first beveled edge and the first tip portion. The second jaw includes a second tip portion, a second beveled edge, and a second plurality of apertures positioned between the second beveled edge and the second tip portion. A pivot pin couples the first jaw to the second jaw for movement of the first jaw and the second jaw about a pivot axis. A longitudinal plane extends perpendicular to the pivot axis. The hand tool further includes a first handle coupled to the first jaw and a second handle coupled to the second jaw. A first cutting recess is defined in a rear upper portion of the first jaw, the first cutting recess faces away from the pivot axis.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front perspective view of a wire stripper, according to an exemplary embodiment.

FIG. 2 is a rear perspective view of the wire stripper of FIG. 1, according to an exemplary embodiment.

FIG. 3 is a front view of the wire stripper of FIG. 1, according to an exemplary embodiment.

FIG. 4 is a rear view of the wire stripper of FIG. 1, according to an exemplary embodiment.

FIG. 5 is front perspective view of the wire stripper of FIG. 1 in a closed position, according to an exemplary embodiment.

FIG. 6 a detailed view of the jaws of the wire stripper of FIG. 1, according to an exemplary embodiment.

FIG. 7 is a front perspective view of a first jaw of the wire stripper of FIG. 1, according to an exemplary embodiment.

FIG. 8 is a rear perspective view of the first jaw of FIG. 7, according to an exemplary embodiment.

FIG. 9 is a front perspective view of a second jaw of the wire stripper of FIG. 1, according to an exemplary embodiment.

FIG. 10 is a rear perspective view of the second jaw of FIG. 9, according to an exemplary embodiment.

FIG. 11 is a top view of the second jaw of FIG. 9, according to an exemplary embodiment.

FIG. 12 is a front view of the second jaw of FIG. 9, according to an exemplary embodiment.

FIG. 13 is a detailed view of the second jaw of FIG. 9, according to an exemplary embodiment.

FIG. 14 is a cross-sectional view of the wire stripping portion of the second jaw, according to an exemplary embodiment.

FIG. 15 is a cross-sectional view of the cutting recesses, according to an exemplary embodiment.

FIG. 16 is a cross-sectional view of a beveled cutting edge, according to an exemplary embodiment.

FIG. 17 is a perspective view of a wire stripper, according to another exemplary embodiment.

FIG. 18 is front view of the wire stripper of FIG. 17, according to an exemplary embodiment.

FIG. 19 is a front perspective view of a wire stripper, according to another exemplary embodiment.

FIG. 20 is a rear perspective view of the wire stripper of FIG. 19, according to an exemplary embodiment.

FIG. 21 is a front view of the wire stripper of FIG. 19, according to an exemplary embodiment.

FIG. 22 a detailed view of the jaws of the wire stripper of FIG. 19, according to an exemplary embodiment.

FIG. 23 is a front perspective view of a first jaw of the wire stripper of FIG. 19, according to an exemplary embodiment.

FIG. 24 is a perspective view of a second jaw of the wire stripper of FIG. 19, according to an exemplary embodiment.

FIG. 25 is a cross-sectional view of a cutting edge of the wire stripper of FIG. 19, according to an exemplary embodiment.

FIG. 26 is a detailed view of the cutting recesses, according to an exemplary embodiment.

FIG. 27 is a detailed view of a connector of the wire stripper, according to an exemplary embodiment.

FIG. 28 is a top view of a cutter of a wire stripper, according to an exemplary embodiment.

FIG. 29 is a detailed view of the cutter of FIG. 28, according to an exemplary embodiment.

FIG. 30 is a detailed view of a cutter of a wire stripper, according to another exemplary embodiment.

FIG. 31 is a detailed view of a surface of the cutter of FIG. 28, according to an exemplary embodiment.

FIG. 32 is detailed view of jaws of a wire stripper, according to an exemplary embodiment.

### DETAILED DESCRIPTION

Referring generally to the figures, various embodiments of a combination hand tool, such as a wire stripper are shown. In the various embodiments of wire strippers discussed herein, the head of the wire stripper and/or the jaws are formed using a metal injection molding (“MIM”) process with the head and/or jaws coupled to separate handle portions. As will generally be understood, in conventional wire strippers, the head and handle components are typically formed by stamping or a forging process in which the head and handle are a single, integral piece of metal. In contrast, the wire strippers discussed herein are formed using MIM allowing for wire strippers having chosen dimensions with tighter tolerances compared to wire strippers formed using stamping or forging processes. For example, as will be discussed in greater detail below, in various embodiments the chosen dimensions include the geometry of the wire stripping portion and/or cutting opening or recess. As will be generally understood, this is typically impractical with wire strippers formed using stamping or forging processes that would require machining in a separate process in order to have specifically chosen dimensions with tight tolerances.

Furthermore, Applicant believes the MIM process allows for desirable stiffness and hardness compared to conventional wire strippers. For example, conventional forged and stamped wire strippers have hardness limitations due to post process machining requirements. In contrast, the wire strippers discussed herein have increased hardness in the jaws and/or portions of the jaws because there are no machining requirements for the jaws formed using the MIM process. In various embodiments, a process following the MIM process can be used to increase the density of the wire strippers and/or wire stripper jaws. In various specific embodiments, the post process is a hot isostatic pressing (“HIP”) process to increase the density of the wire strippers and/or wire stripper jaws. Applicant believes the use of a HIP process allows for desirable stiffness from the MIM process along with strength similar to forged wire strippers.

Finally, in various embodiments of the wire strippers discussed herein, one or more jaws include a cutting opening or recess on a rear portion of the jaw. Applicant believes the cutting opening or recess allows for improved leverage and durability for cutting metal such as metal wires. In various specific embodiments, the cutting opening or recess has a surface with an angled cutting edge. In various specific embodiments, the cutting opening or recess has surface or edge with an increased hardness relative to the jaw.

In various specific embodiments, the strippers discussed herein, the head of the wire stripper and/or the jaws are formed using stamping. In various specific embodiments, the stamped strippers include one or more jaws include a cutting opening or recess on a rear portion of the jaw. Applicant believes the cutting opening or recess allows for improved leverage and durability for cutting metal such as metal wires.

In one or more embodiments, portions of the wire strippers are coupled together using a connector such as a rivet. In such embodiments, the rivet is received within a counterbore such that the rivet is flush with the wire stripper jaws. Applicant believe that the thinner profile of the rivet improves ergonomics of the wire strippers and avoids pain to the user that may be caused by engagement between a user's hand and a raised connector or rivet.

In one or more specific embodiments, the strippers discussed herein include a cutter coin feature positioned around an axis of rotation of the jaws. In a specific embodiments, the cutter coin extends to a cutting opening or recess on a portion of the jaw. In one or more embodiments, the cutter coin has a projected surface that is angled relative to the outer surface of the jaw. Applicant has found the angled surface removes a gap that would otherwise exist between the first and second jaws.

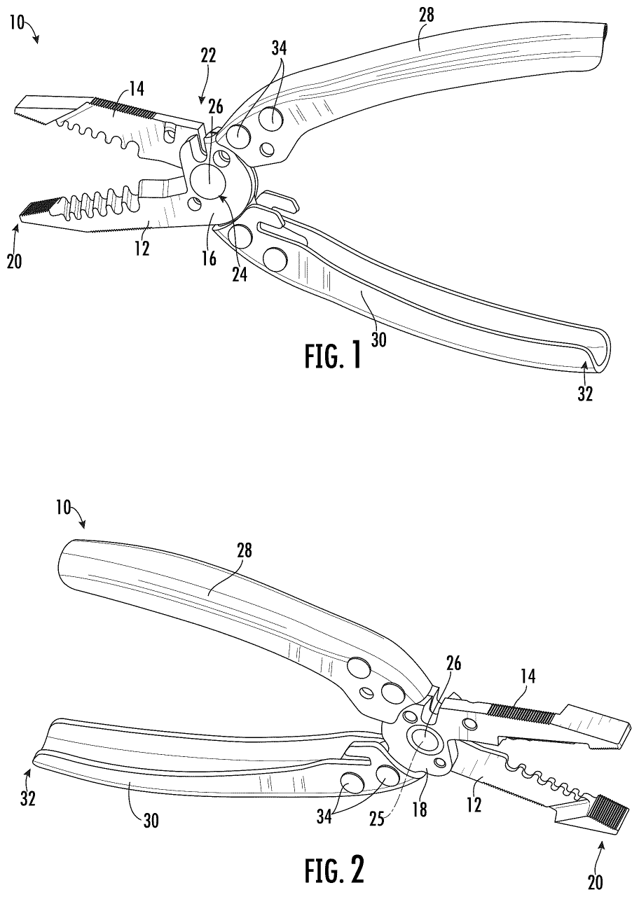

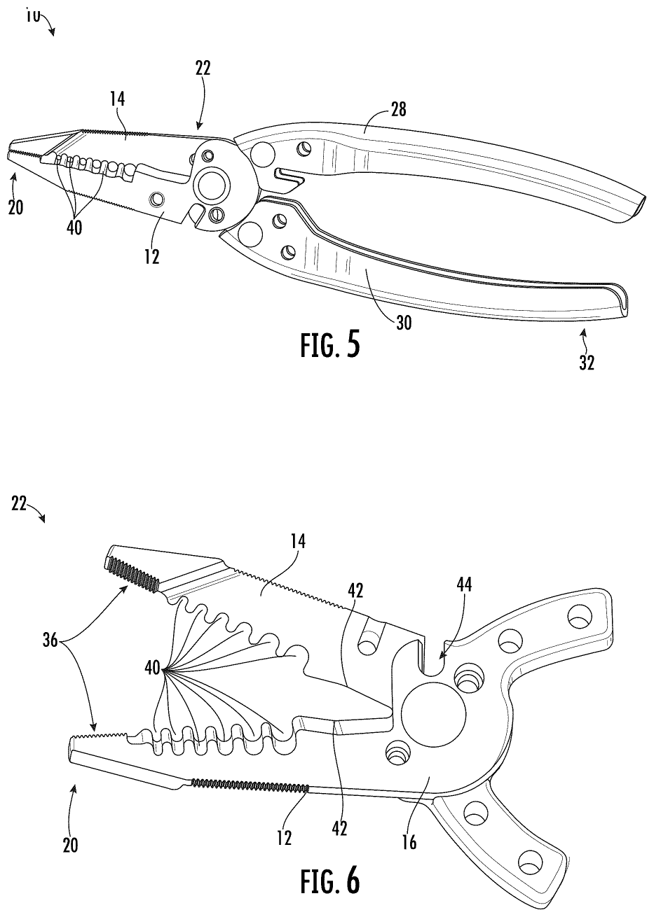

Referring to FIGS. 1-4, details of a combination hand tool, shown as wire stripper 10, are shown according to an exemplary embodiment. In various embodiments, wire stripper 10 includes a pliers tip (see e.g., 20) and/or a cutting recess (see e.g., 44, 46 in FIGS. 5 and 8). Wire stripper 10 includes a first jaw 12 and second jaw 14 that together form a head 22. As will be generally understood, first jaw 12 has a first tip and second jaw 14 has a second tip with each of the first tip and second tip having a gripping surface 36 (see e.g., FIG. 6).

Wire stripper 10 further includes a first handle 28 coupled to first jaw 12 and a second handle 30 coupled to second jaw 14. Wire stripper 10 extends from a tip 20 to a handle end 32. In other words, first handle 28 extends between a proximal end coupled to the first jaw 12 and a distal end positioned at handle end 32. Similarly, second handle 30 extends between a proximal end coupled to second jaw 14 and a distal end positioned at handle end 32.

First jaw 12 includes a first pivot portion 16 positioned between the tip 20 and first handle 28. Second jaw 14 includes a second pivot portion 18 positioned between tip 20 and second handle 30. The first jaw 12 and the second jaw 14 and specifically the tips 20 together define a nose 23 of the wire stripper 10. In various specific embodiments, each jaw 12, 14 does not taper. In various other embodiments, each jaw 12, 14 may taper to a narrow pliers end. The first pivot portion 16 and second pivot portion 18 each define a pivot aperture 24. The first and second jaws 12, 14 are pivotally coupled about a pivot axis 25 defined by a pivot pin 26 disposed within the pivot apertures 24. The wire strippers 10 are pivotable about pivot axis 25 of the pivot pin 26 between a closed position and an open position. In the closed position (see e.g., FIG. 5), the jaws 12, 14 are in contact with one another. In the open position as illustrated in FIGS. 1-2, the jaws 12, 14 are spaced from one another.

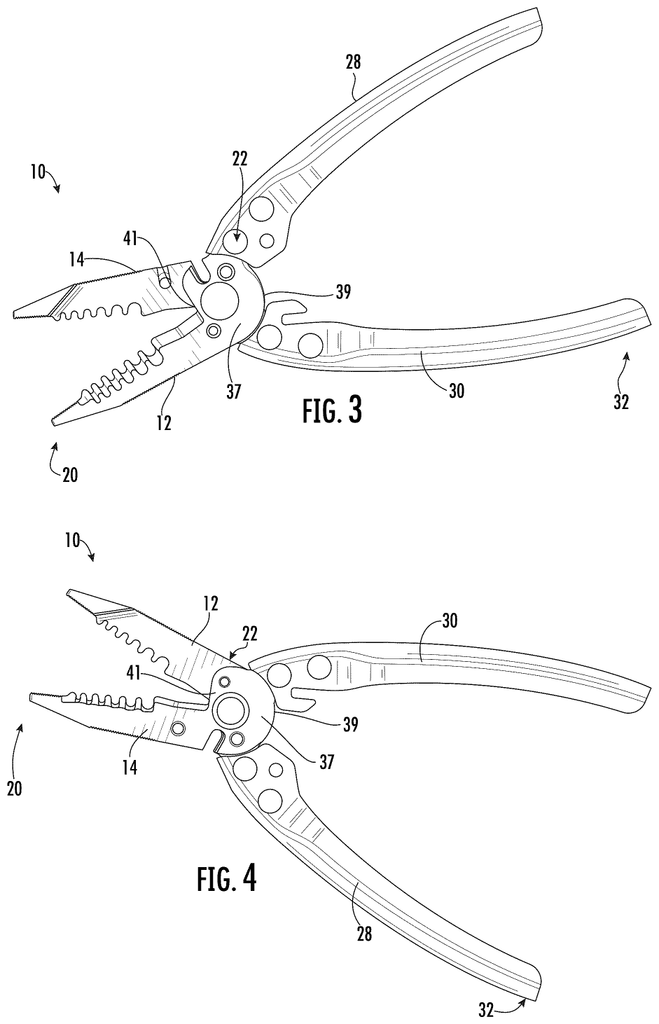

As shown in FIGS. 3-4, each of the pivot portions 16, 18 has a flat surface 37, a circumferential surface 39, and a front or longitudinally facing surface 41 that extends from the flat surface 37. The pivot portions 16, 18 are configured to engage such that the flat surfaces 37 of the pivot portions 16, 18 abut. As the jaws 12, 14 pivot relative to one another about the pivot axis 25, the front or longitudinally facing surface 41 continue to face forward or along a longitudinal axis of the wire stripper 10.

As previously noted, in contrast to typical wire strippers formed through stamping or forging such that the jaws and handle are formed integrally, the head 22 of the wire stripper 10 and/or the jaws 12, 14 are formed using a metal injection molding (“MIM”) process. As such, head 22 and/or jaws 12, 14 are not integrally formed with handles 28, 30. In other words, jaws 12, 14 are separate, non-integral components from handles 28, 230. As will be discussed in greater detail below, Applicant believes the MIM process allows for wire strippers 10 to have desirable stiffness and/or hardness compared to conventional wire strippers. Furthermore, the use of a MIM process allows for tighter tolerances compared to wire strippers formed using stamping or forging processes. In various specific embodiments, the MIM process means wire stripper 10 has a 0.3% deviation in feature size.

In various embodiments, a process following the MIM process is be used to increase the density of the wire strippers 10 and/or wire stripper jaws 12, 14. In various specific embodiments, the post process is a hot isostatic pressing (“HIP”) process to increase the density of the wire strippers 10 and/or wire stripper jaws 12, 14. As previously noted, Applicant believes the use of a HIP process allows for desirable stiffness from the MIM process along with strength similar to forged wire strippers. For example, in various specific embodiments, wire stripper 10 has a density of about 97% following the MIM process. In such an embodiment, wire stripper 10 has a density of about 99.9% following the HIP process. In various specific embodiments, jaws 12, 14 have an ultimate tensile strength of about 2300 MPa (e.g., 2300 MPa plus or minus 115 MPa).

In various embodiments, wire stripper 10 includes jaws 12, 14 formed using metal injection molding. In specific embodiments, jaws 12, 14 are formed from a first material and handles 28, 30 are formed from a second material that is different than the first material. In specific embodiments, jaws 12, 14 are formed from a first metal material and handles 28, 30 are formed from a second metal material. In such embodiments, the first metal material is different than the second metal material. In various embodiments, jaws 12, 14 are formed from the first metal material having a first weight and handles 28, 30 are formed from a second metal material having a second weight. In such embodiments, the second weight is less than the first weight. Applicant believes having wire strippers 10 formed from multiple components (e.g., separate jaws, handles, etc.) allows for overall weight reduction of wire stripper 10.

In various embodiments, the first material is steel. In other words, jaws 12, 14 are formed from steel. In various specific embodiments, jaws 12, 14 are formed from 100Cr6. In various specific embodiments, jaws 12, 14 are formed from 440C. In various specific embodiments, jaws 12, 14 are formed from a tool steel, S7. In various specific embodiments, the second material is at least one of aluminum, steel (e.g., stamped steel), magnesium, and titanium.

Referring to FIGS. 5-10, details of head 22 and jaws 12, 14 of wire stripper 10 are shown according to an exemplary embodiment. As shown in FIG. 5, apertures 40 extend through the jaws 12, 14 of the wire stripper 10. The jaws 12,14 cooperate to form the apertures 40, with a portion (e.g., one half) of each aperture 40 being formed in each jaw 12, 14. The apertures 40 are constructed and arranged to strip insulation from a wire, without substantial penetration of the underlying wire core. Each aperture 40 has a different diameter so that each aperture may be used to strip wire of a different size or gauge. In various specific embodiments, apertures 40 are configured to be used with 10-18 gauge wire. In various specific embodiments, apertures 40 are configured to be used with 6-18 gauge wire.

The apertures 40 are arranged in a bypass configuration. The first jaw 12 and second jaw 14 each include a beveled edge 42 extending along a length of the jaw 12, 14 and directly from the front or longitudinally facing surfaces 41 of the pivot portions 16, 18. As will generally be understood, beveled edge 42 is configured to allow jaws 12, 14 to cooperate and cut an object and/or wire. For example, in various embodiments, beveled edge 42 is configured to cut at least one of copper, aluminum, and galvanized steel.

Referring to FIGS. 5 and 16, details of beveled edge 42 are shown according to exemplary embodiments. As shown in FIG. 16, beveled edges 42 of jaws 12, 14 have an angle 51 relative to an internal or inward facing sides of jaw 12 and jaw 14 respectively. In other words, beveled edges 42 of jaw 12, 14 have an angle 51 relative to the side surface that faces the longitudinal axis. In various specific embodiments, beveled edge 42 has an angle 51 of about 55 degrees (e.g., 55 degrees plus or minus 3 degrees). In various embodiments, beveled edge 42 has an angle 51 between 52 and 58 degrees, specifically between 53 and 57 degrees, and more specifically between 54 and 56 degrees. Applicant has found that angles within the ranges discussed herein for beveled edge 42 along with localized hardness increases allows beveled edges 42 to cut materials such as galvanized steel. Additionally, angles less than the ranges discussed herein for beveled edges 42 results in degradation and angles above the ranges discussed herein are too steep to achieve desired cut quality.

To provide the bypass configuration while having the jaws 12, 14 overlie each other, complementary open areas are provided (e.g., material is removed) in the area of the bypass. Therefore, on one jaw 12, the structure defining the apertures 40 and the beveled edge 42 is provided on one side of a longitudinal plane, while, on the other jaw 14, the structure is provided on the other side of that plane. Each jaw 12, 14 defines an open area to receive the structure of the other jaw 12,14 as the jaws 12, 14 are closed (see e.g., FIG. 5).

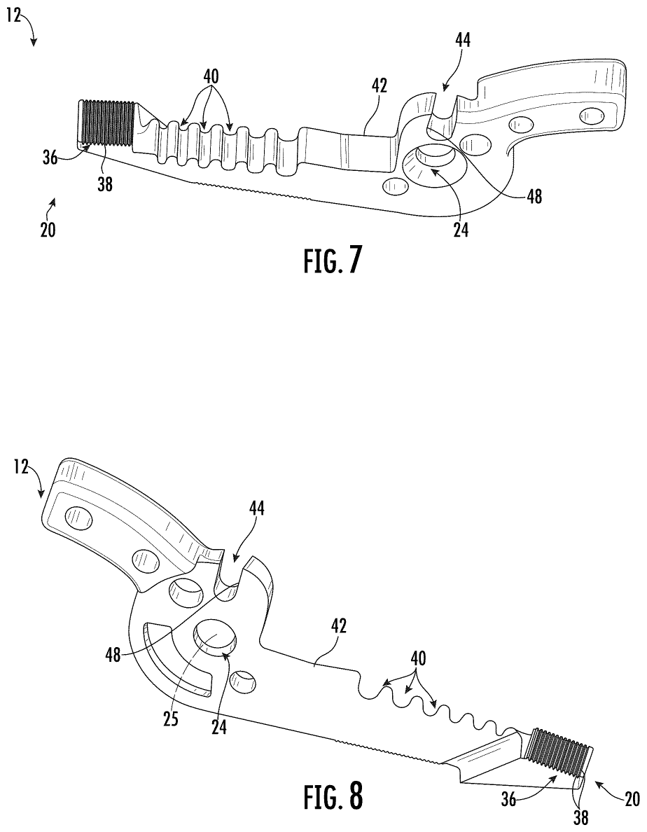

Referring to FIGS. 7-10, details of jaws 12, 14 of wire stripper 10 are shown according to an exemplary embodiment. Jaws 12, 14 each include a gripping surface 36 at tip 20 of wire stripper 10. In various embodiments, gripping surface 36 is in a plane parallel to pivot axis 25. In various specific embodiments, gripping surface 36 has a plurality of ridges 38. In other words, in such embodiments, gripping surface 36 is a ridged gripping surface. In various embodiments, the apertures 40 are positioned between the gripping surface 36 of each of the first and second jaws 12, 14 and pivot pin 26. In various embodiments, the apertures 40 are positioned between the gripping surface 36 of each of the first and second jaws 12, 14 and the respective beveled edge 42.

First jaw 12 includes a first cutting opening or recess 44 on a rear portion of the jaw 12. In various embodiments, cutting recess 44 is defined in an outward facing surface of jaw 12 adjacent to pivot aperture 24 and/or pivot pin 26. In specific embodiments, cutting recess 44 is positioned above pivot aperture 24 in the orientation shown in FIG. 7. In specific embodiments, cutting recess 44 is positioned on a rear, upper portion first jaw 12 and faces upward and away from pivot axis 25. In specific embodiments, cutting recess 44 is aligned with the pivot pin 26 in a longitudinal direction. In other words, cutting recess 44 has a width defined along a major or longitudinal axis of pivot pin 26.

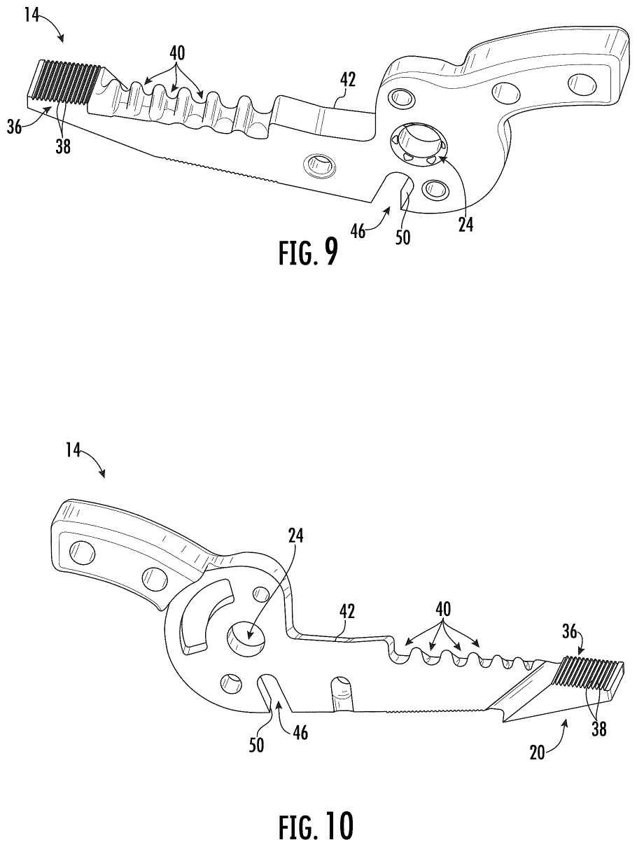

Second jaw 14 includes a second cutting opening or recess 46 on a rear portion of the jaw 14. In various embodiments, second cutting recess 46 is defined in an outward facing surface of jaw 14 adjacent to pivot aperture 24. In specific embodiments, second cutting recess 46 is positioned below pivot aperture 24 in the orientation shown in FIG. 9. In specific embodiments, cutting recess 46 is positioned on a rear, lower portion second jaw 14 and faces downward and away from pivot axis 25. In specific embodiments, cutting recess 46 is aligned with the pivot pin 26 in a longitudinal direction. In other words, cutting recess 46 has a width defined along the major or longitudinal axis of pivot pin 26. As will generally be understood, while beveled edge 42 acts as a cutter, first cutting recess 44 and second cutting recess 46 are configured to cut more robust materials (e.g., steel, etc.).

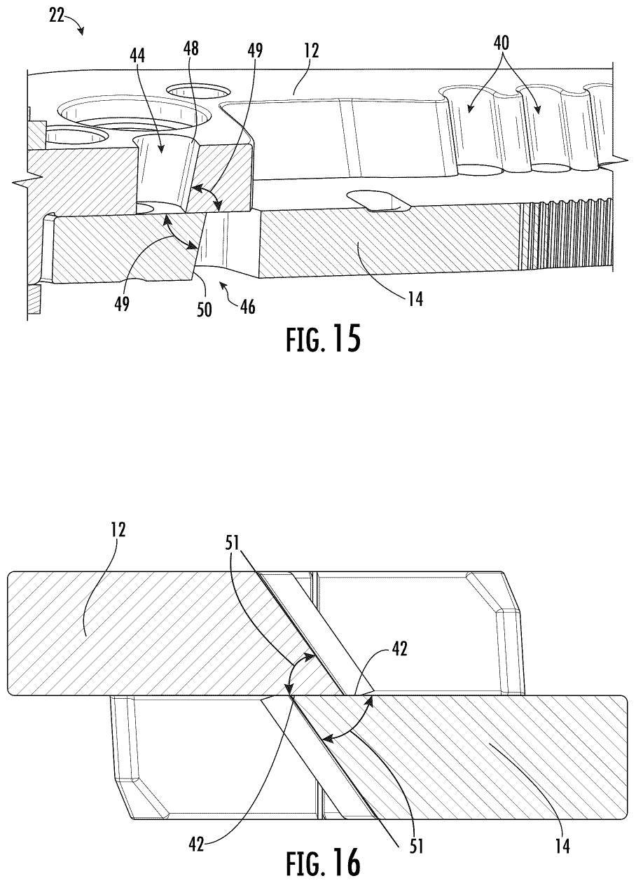

As shown in FIGS. 8 and 15, first cutting recess 44 includes one or more cutting edges 48. In various specific embodiments, first cutting recess 44 forms a U-shape. In various embodiments, while cutting edge 48 is angled, the opposing edge of cutting recess 44 is square (e.g., about 90 degrees or same orientation as pivot axis 25). As shown in FIG. 15, cutting edge 48 has an angle 49 relative to an internal or inward facing side of jaw 12. In various specific embodiments, cutting edge 48 has an angle 49 of about 80 degrees (e.g., 80 degrees plus or minus 3 degrees). In various embodiments, cutting edge 48 has an angle 49 between 77 and 83 degrees, specifically between 78 and 82 degrees, and more specifically between 79 and 81 degrees. Applicant has found that angles below the ranges discussed herein for cutting edge 48 results in degradation and that angles above the ranges discussed herein are too steep to achieve desired cut quality.

As shown in FIG. 10, second cutting recess 46 includes one or more cutting edges 50. In various specific embodiments, second cutting recess 46 forms a U-shape. In various embodiments, while cutting edge 50 is angled, the opposing edge of cutting recess 46 is square (e.g., about 90 degrees). As shown in FIG. 15, cutting edge 50 has an angle 49 relative to an internal or inward facing side of jaw 14. In various specific embodiments, cutting edge 50 has an angle 49 of about 80 degrees (e.g., 80 degrees plus or minus 3 degrees). In various embodiments, cutting edge 50 has an angle 49 between 77 and 83 degrees, specifically between 78 and 82 degrees, and more specifically between 79 and 81 degrees. In various specific embodiment, the angle cutting edge 48 of first cutting recess 44 is the same as the angle of cutting edge 50 of second cutting recess 48. As noted previously, Applicant has found that angles below the ranges discussed herein for cutting edge 50 results in degradation and that angles above the ranges discussed herein are too steep to achieve desired cut quality.

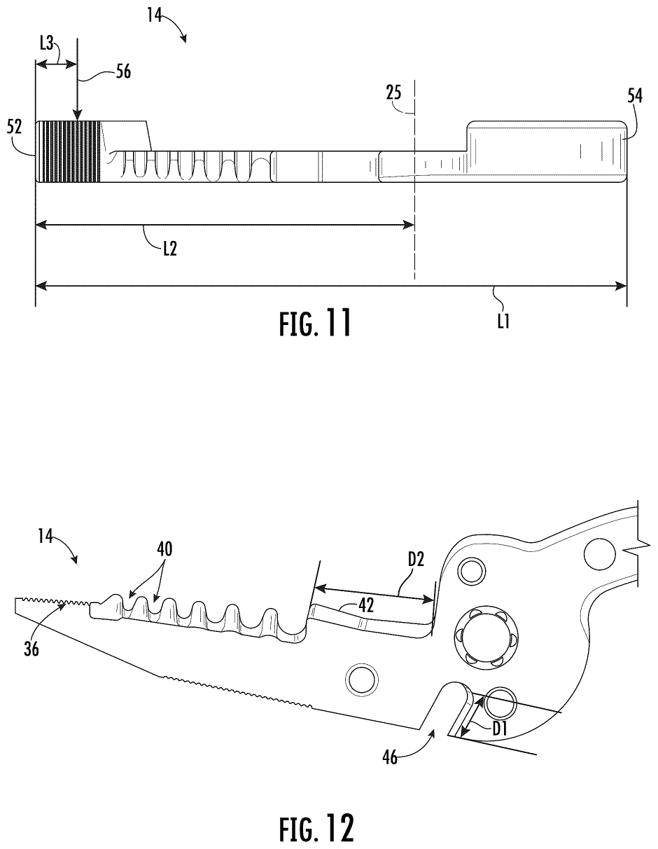

Referring to FIG. 11, a top view of second jaw 14 is shown according to an exemplary embodiment. As noted above, Applicant believes the MIM process allows for desirable stiffness of jaws 12, 14 compared to conventional wire strippers. Jaws 12, 14 have a stiffness or a spring constant of between 450 N/mm and 550 N/mm, specifically between 475 N/mm and 525 N/mm and more specifically between 500 N/mm and 525 N/mm when a force is applied in a direction parallel to the pivot axis 25. In various specific embodiments, jaws 12, 14 have a stiffness or spring constant of about 512 N/mm (e.g., 512 N/mm plus or minus 10 N/mm).

As shown in FIG. 11, the stiffness or spring constant of jaws 12, 14 discussed herein are when a force 56 is applied in a direction parallel to the pivot axis 25. Jaw 14 has a total length, L1 defined between a front edge 52 at tip 20 and an opposing rear edge 54. In various specific embodiments, L1 is about 92 mm (e.g., 92 mm plus or minus 10 mm). Front edge 52 is a second distance or length L2 away from pivot axis 25. In various specific embodiments, L2 is about 52 mm (e.g., 52 mm plus or minus 5 mm). In various embodiments, force 56 is applied a distance L3 from the front edge 52 of jaw 14 in a direction parallel to pivot axis 25. In various specific embodiments, L3 is about 5 mm (e.g., 5 mm plus or minus 0.5 mm). In various specific embodiments, force 56 is about 1000 N. In various embodiments, force 56 is 1000 N and applied in a direction parallel to pivot axis 25 at a location 5 mm from front edge 52 of tip 20. In various embodiments, first jaw 12 has the same stiffness or spring constant as second jaw 14.

Referring to FIG. 12, details of second jaw 14 are shown according to an exemplary embodiment. As previously discussed, the wire stripper 10 discussed herein have increased hardness in the jaws 12, 14 and/or specific portions of the jaws 12, 14 because there are no machining requirements for the jaws 12, 14 formed using the MIM process. In various embodiments, jaws 12, 14 have a hardness greater than 59 HRC or Rockwell hardness. In various specific embodiments, jaws 12, 14 have a hardness from 59 to 64 HRC, specifically from 60 to 63 HRC, and more specifically 60 to 62 HRC. In various specific embodiments, jaws 12, 14 have a hardness of about 61 HRC (e.g., 61 HRC plus or minus 2 HRC).

In various embodiments, jaws 12, 14 have an increased hardness is specific portions of jaws 12, 14. In other words, jaws 12, 14 have localized hardness increases. In such embodiments, the localized hardness introduction is after the MIM process. In various specific embodiments, the localized hardness is introduced to jaws 12, 14 using induction hardening. In various specific embodiments, the localized hardness on jaws 12, 14 has a depth of about 5 mm from the surface. In other specific embodiments, the localized hardness on jaws 14, 16 has a depth of about 0.5 mm from the surface.

For example, in various embodiments, jaws 12, 14 have an increased hardness in the second cutting recess 46 and/or first cutting recess 44 respectively. In such embodiments, jaws 12, 14 have a first hardness and a dimension D1 of cutting recesses 44, 46 has a second hardness that is greater than the first hardness. In various specific embodiments, the dimension D1 is a length of cutting edge 50 (see e.g., FIG. 12) and a length of cutting edge 48. In various specific embodiments, the length of cutting edge 48 is the same as the length of cutting edge 50. In various embodiments, D1 is between 0.15 and 0.30 inches, specifically between 0.175 and 0.275 inches, and more specifically between 0.19 and 0.22. In various specific embodiments, D1 is about 0.211 inches (e.g., 0.211 inches plus of minus 0.05 inches).

In various embodiments, the second hardness is greater than 60 HRC and more specifically greater than 62 HRC. In various embodiments, the second hardness is between 61 HRC and 65 HRC. In specific embodiments, the second hardness is about 64 HRC (e.g., 64 HRC plus or minus 2 HRC). In various specific embodiments, the second hardness from 63.5 to 64.5 HRC. Applicant has found that hardness below the ranges discussed herein for the second hardness results in durability problems and that hardnesses above the ranges discussed herein become too brittle.

In various embodiments, jaws 12, 14 have an increased hardness along beveled edge 42. In such embodiments, jaws 12, 14 have a first hardness and a dimension D2 of beveled edge 42 has a third hardness that is greater than the first hardness. In various specific embodiments, the dimension D2 is between 0.4 and 0.8 inches, specifically between 0.5 and 0.7 inches, and more specifically between 0.55 and 0.65 inches. In various embodiments, D2 is about 0.61 inches (e.g., 0.61 inches plus or minus 0.05 inches). In various embodiments, the third hardness is greater than 60 HRC and more specifically greater than 62 HRC. In various embodiments, the third hardness is from 61HRC to 65 HRC. In specific embodiments, the third hardness is about 64 HRC (e.g., 64 HRC plus or minus 2HRC). In various specific embodiments, jaws 12, 14 have localized hardness increases in the cutting recesses 44, 46 and along beveled edges 42. In various specific embodiments, the third hardness is from 63.5 to 64.5 HRC. Again, Applicant has found that hardness below the ranges discussed herein for the thirdness hardness results in durability problems and that hardnesses above the ranges discussed herein become too brittle.

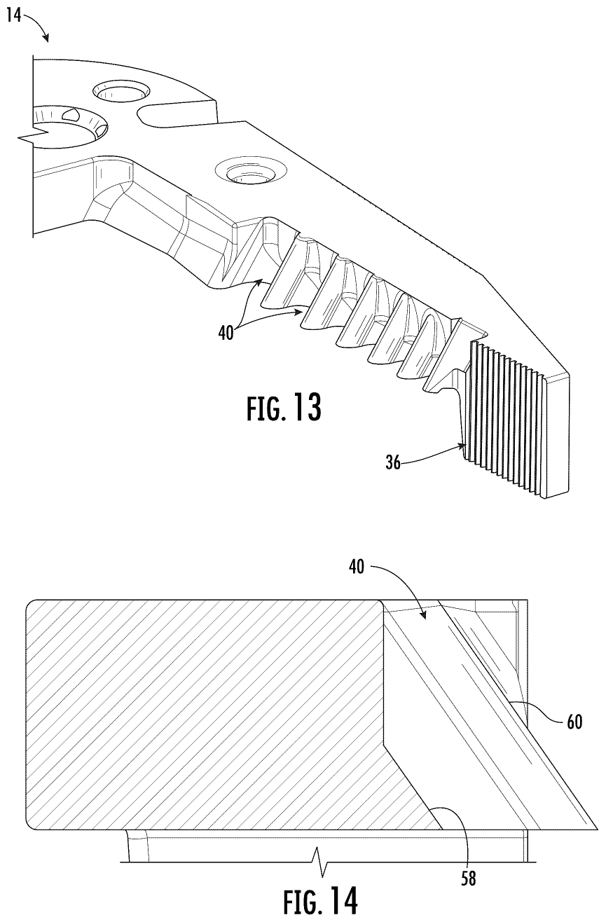

Referring to FIGS. 13-14, details of apertures 40 are shown according to an exemplary embodiment. Unlike conventional wire strippers that may have apertures or stripping features all in one constant plane, Applicant believes the use of MIM allows for jaws 12, 14 to have apertures 40 with multiple bevels. Applicant believes such multi bevel designs improve the overall bending strength of wire stripper 10. For example, as shown in FIG. 14, an aperture 40 has more than one angled edge. In various embodiments, aperture 40 includes a first angled edge 58 and a second angled edge 60 such that aperture 40 has a multi bevel design. In various other embodiments, aperture 40 includes more angled edges (e.g., three, four, five, etc.).

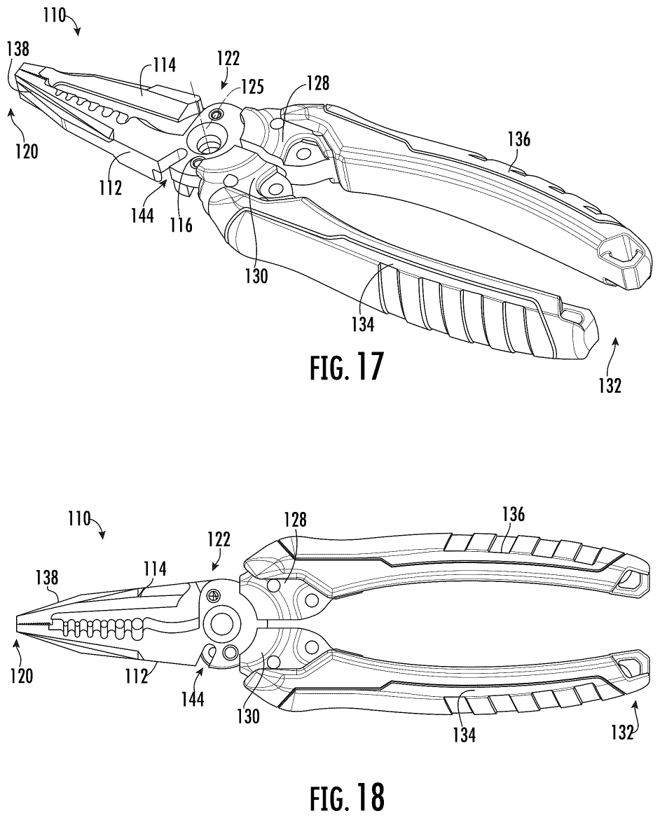

Referring to FIGS. 17-18, details of a wire stripper 110 are shown according to an exemplary embodiment. Wire stripper 110 is substantially the same as wire stripper 10 except for the differences discussed herein. Jaw 112 and/or jaw 114 of wire stripper 110 include an angled edge 138. Angled edge 138 is configured to be used for reaming. In various embodiments, first handle 128 and second handle 130 each include a grip or cover 134, 136. In various embodiments, grips 134, 136 are formed from a slip resistant material (e.g., polymer, rubber, etc.). grips 134, 136 can be utilized with handles 28, 30 of wire stripper 10.

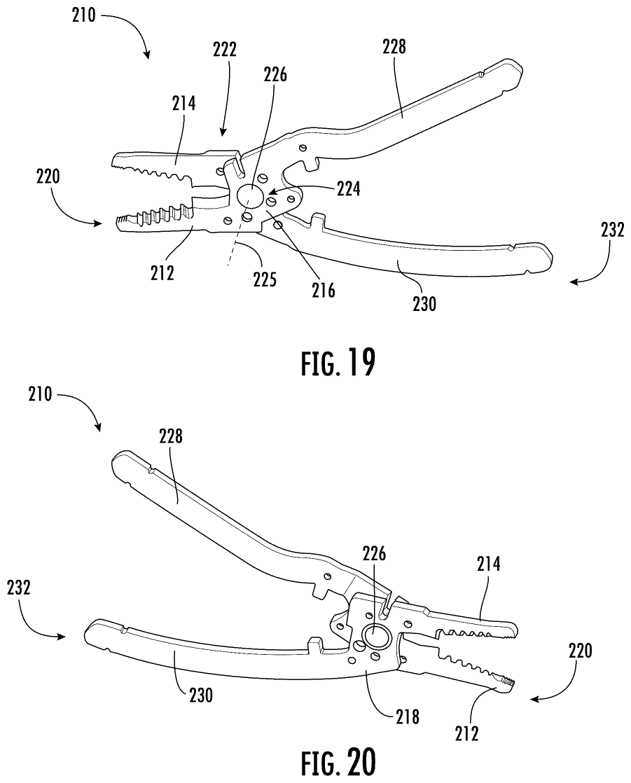

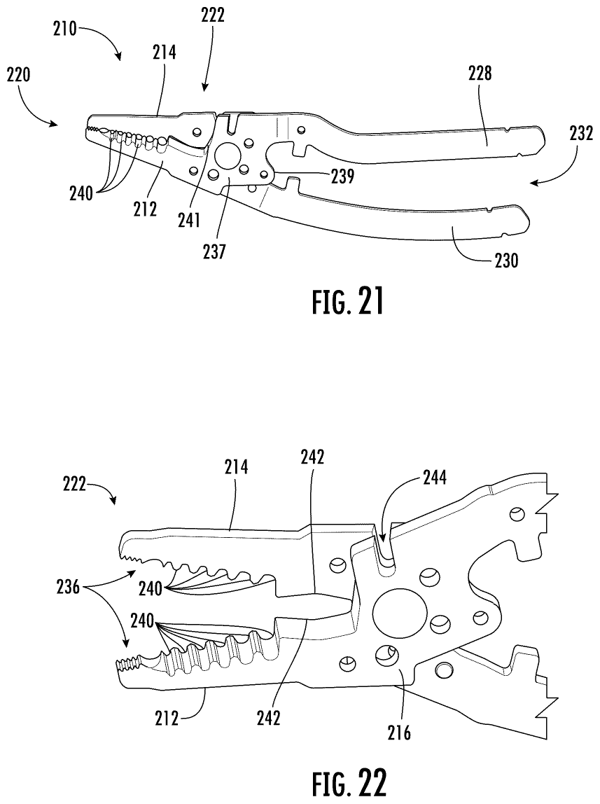

Referring to FIGS. 19-22, details of a wire stripper 210 are shown according to an exemplary embodiment. Wire stripper 210 is substantially the same as wire stripper 10 except for the differences discussed herein. In specific embodiments, wire stripper 210 is formed using stamping. In one or more specific embodiments, jaw 212 and/or jaw 214 of wire stripper 210 are formed using stamping.

In various embodiments, wire stripper 210 is formed from steel. In various specific embodiments, jaws 212, 214 are formed from 1075 steel. In various embodiments, jaws 212, 214 have a hardness greater than 60 HRC. In various specific embodiments, jaws 212, 214 have a hardness from 61 to 64 HRC. In various embodiments, jaws 212, 214 have a thickness greater than 3.2 mm. In specific embodiments, each jaw 212, 214 has a thickness of about 4 mm.

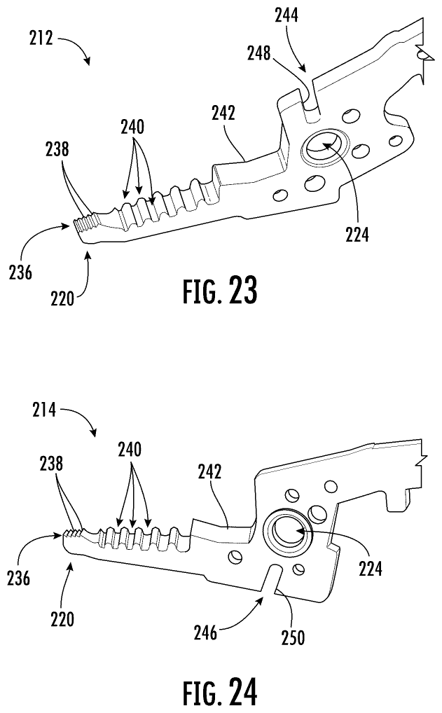

As shown in FIGS. 23-26, a first cutting recess 244 includes one or more cutting edges 248. In various specific embodiments, first cutting recess 244 forms a U-shape. In various embodiments, while cutting edge 248 is angled, the opposing edge of cutting recess 244 is square (e.g., about 90 degrees or same orientation as pivot axis 225). As shown in FIG. 26, cutting edge 248 has an angle 249 relative to an internal or inward facing side of jaw 212. In various specific embodiments, cutting edge 248 has an angle 249 of about 80 degrees (e.g., 80 degrees plus or minus 3 degrees). In various embodiments, cutting edge 248 has an angle 249 between 77 and 83 degrees, specifically between 78 and 82 degrees, and more specifically between 79 and 81 degrees. Applicant has found that angles below the ranges discussed herein for cutting edge 248 results in degradation and that angles above the ranges discussed herein are too steep to achieve desired cut quality.

A second cutting recess 246 includes one or more cutting edges 250. In various specific embodiments, second cutting recess 246 forms a U-shape. In various embodiments, while cutting edge 250 is angled, the opposing edge of cutting recess 246 is square (e.g., about 90 degrees). As shown in FIG. 26, cutting edge 250 has an angle 49 relative to an internal or inward facing side of jaw 214. In various specific embodiments, cutting edge 250 has an angle 249 of about 80 degrees (e.g., 80 degrees plus or minus 3 degrees). In various embodiments, cutting edge 50 has an angle 49 between 77 and 83 degrees, specifically between 78 and 82 degrees, and more specifically between 79 and 81 degrees. In various specific embodiment, the angle cutting edge 248 of first cutting recess 244 is the same as the angle of cutting edge 250 of second cutting recess 248.

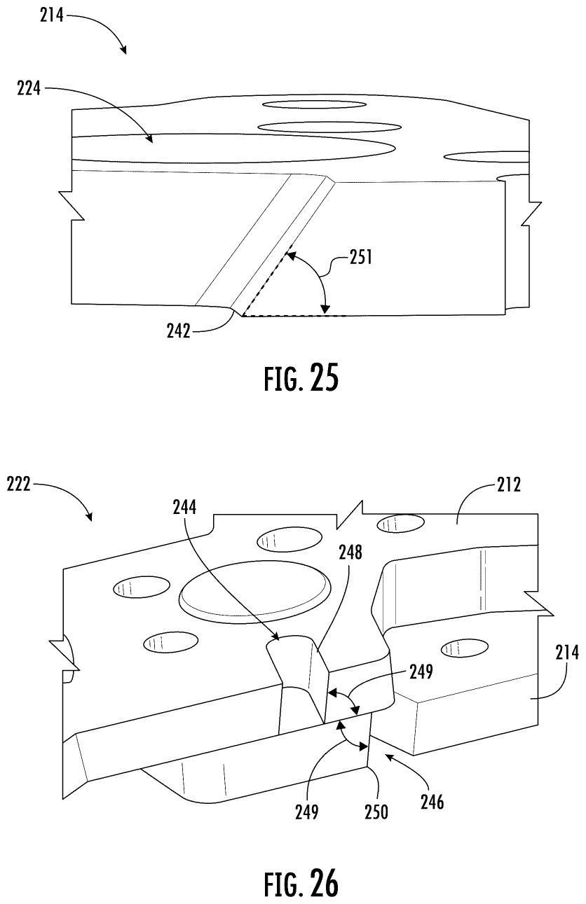

Referring to FIG. 25, details of beveled edge 242 are shown according to an exemplary embodiment. Beveled edges 242 of jaw 212 and/or jaw 214 have an angle 251 relative to an internal or inward facing sides of jaw 212 and jaw 214 respectively. In other words, beveled edges 242 of jaw 212, 214 have an angle 251 relative to the side surface that faces the longitudinal axis. In various specific embodiments, beveled edge 242 has an angle 251 of about 55 degrees (e.g., 55 degrees plus or minus 3 degrees). In various embodiments, beveled edge 242 has an angle 251 between 52 and 58 degrees, specifically between 53 and 57 degrees, and more specifically between 54 and 56 degrees.

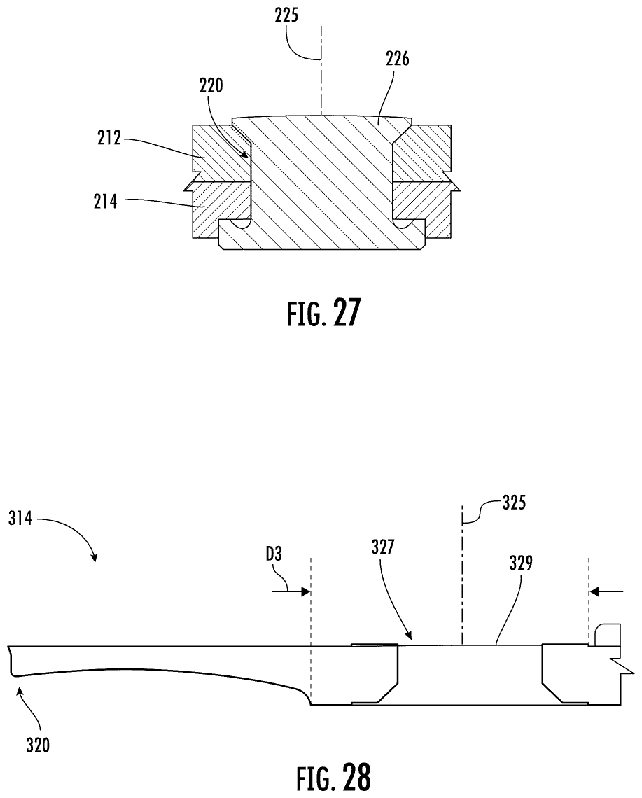

Referring to FIG. 27, details of a connector, shown as rivet 226, are shown according to an exemplary embodiment. In one or more embodiments, the rivet 226 is received within a counterbore 224 such that the rivet 226 is closer to flush with the wire stripper jaws 212. 214. Applicant believe that the thinner profile of the rivet 226 improves ergonomics of the wire strippers 210.

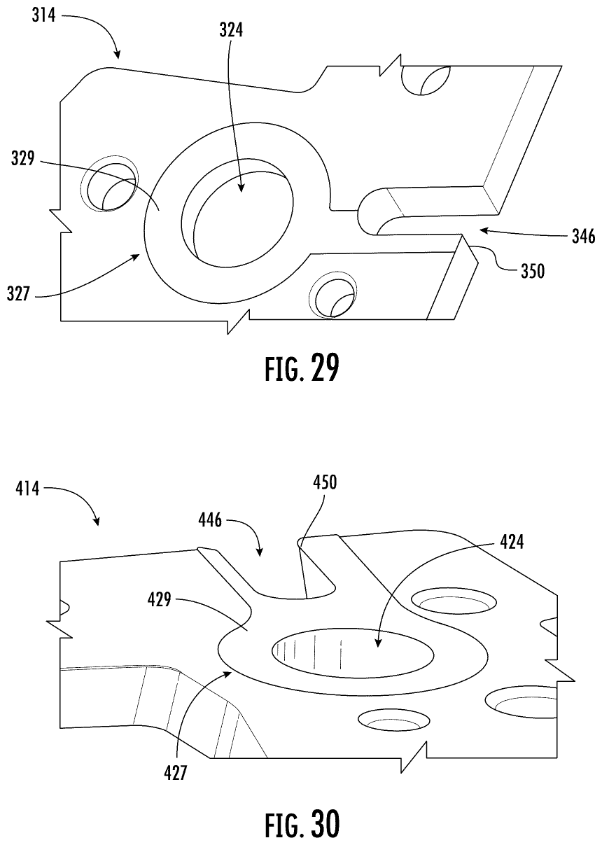

Referring to FIGS. 28-29, details of a cutting feature, shown as cutter 327 of wires strippers 310 are shown according to an exemplary embodiment. Wire stripper 310 is substantially the same as wire stripper 10, 110, 210 except for the differences discussed herein. Cutter 327 can be utilized with wire stripper 10, 110, 210. Cutter 327 surrounds a pivot axis 325 of wire strippers 310. In one or more embodiments, cutter 327 surrounds bore 324. In one or more specific embodiments, cutter 327 surrounds pivot axis 325 and extends away from pivot axis 325 to a cutting recess 346. In such embodiments, cutter 327 includes a cutting edge 350 of cutting recess 346. In one or more specific embodiments, cutter 327 is formed from steel.

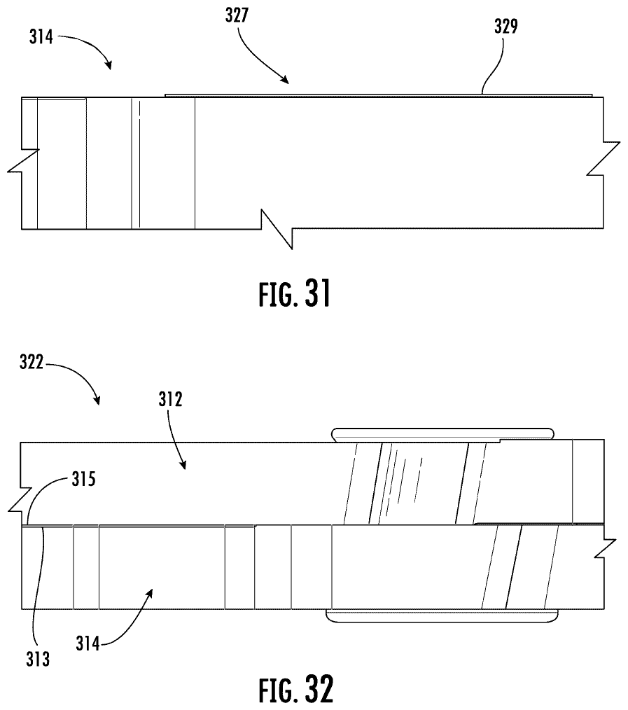

In one or more specific embodiments, a portion of cutter 327 surrounding pivot axis 325 has a diameter, D3, of 13 mm. As shown in FIG. 31, in one or more specific embodiments, cutter 327 projects outward from an outer surface of jaw 314 by 0.1 mm. In one or more specific embodiments, exterior surface 329 of cutter 327 is angled relative to an outer surface 313 of jaw 314. In one or more embodiments, an angle of exterior surface 328 is greater than a minimum angle.

While a projecting surface creates a gap between jaw 314 and jaw 312 and in particular between outer surface 313 of jaw 314 and outer surface 315 of jaw 312 having an angled exterior surface 329 eliminates such a gap as shown in FIG. 32. Applicant has found an angled surface 329 allows for the tips of jaws 312, 314 to engage first when jaws 312, 314 move about pivot axis 325 into a closed position.

Referring to FIG. 30, details of a cutting feature, shown as cutter 427 are shown according to another exemplary embodiment. Cutter 427 can be utilized with wire stripper 10, 110, 210, 310. Cutter 427 surrounds a bore 424 that defines a pivot axis. In one or more specific embodiments, cutter 427 surrounds bore 424 and extends away from bore 424 to a cutting recess 446. In such embodiments, cutter 427 includes a cutting edge 450 of cutting recess 446 and the opposing edge of cutting recess 446. In specific embodiments, the opposing edge is square (e.g., about 90 degrees or same orientation as pivot axis). In one or more specific embodiments, cutter 427 is formed from steel.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A hand tool comprising:
a first jaw, the first jaw comprising:
a first tip portion; and
a first plurality of apertures;
a second jaw, the second jaw comprising:
a second tip portion; and
a second plurality of apertures;
a pivot pin coupling the first jaw to the second jaw for movement of the first jaw and the second jaw about a pivot axis;
a first handle is coupled to the first jaw; and
a second handle is coupled to the second jaw; and
a cutting recess defined in at least one of the first jaw and the second jaw, the cutting recess aligned with the pivot pin in a longitudinal direction;
wherein the first jaw and the second jaw are separate, non-integrally formed with the first handle and the second handle.

2. The hand tool of claim 1, wherein the first jaw and the second jaw each have a first hardness, wherein the first hardness greater than 59 HRC.

3. The hand tool of claim 2, wherein the first hardness is less than 64 HRC.

4. The hand tool of claim 2, wherein the cutting recess has a second hardness, and wherein the second hardness is greater than the first hardness.

5. The hand tool of claim 4, wherein the second hardness is between 61 HRC and 65 HRC.

6. The hand tool of claim 1, wherein the first jaw and the second jaw each have a spring constant between 450 N/mm and 550 N/mm, measured when a force is applied in a direction parallel to the pivot axis to an associated jaw tip with the pivot pin being held.

7. The hand tool of claim 1, wherein the first jaw and the second jaw are formed using metal injection molding.

8. The hand tool of claim 1, wherein the first jaw and the second jaw are formed from a first metal material, wherein the first handle and the second handle are formed from a second metal material, and wherein the first metal material is different than the second metal material.

9. The hand tool of claim 8, wherein the first metal material is 100Cr6.

10. The hand tool of claim 8, wherein the second metal material is one of aluminum, steel, magnesium, and titanium.

11. A wire stripper comprising:
a first jaw, the first jaw comprising:
a first tip portion; and
a first plurality of apertures, each of the first plurality of apertures comprising:
a first angled edge; and
a second angled edge;
a second jaw, the second jaw comprising:
a second tip portion; and
a second plurality of apertures;
a pivot pin coupling the first jaw to the second jaw for movement of the first jaw and the second jaw about a pivot axis;
a first handle is coupled to the first jaw; and
a second handle is coupled to the second jaw; and
wherein the first jaw and the second jaw are separate, non-integrally formed with the first handle and the second handle.

12. The wire stripper of claim 11, wherein the first jaw further comprises a beveled edge extending along a length of the first jaw, the beveled edge positioned between the first plurality of apertures and the pivot pin.

13. The wire stripper of claim 12, wherein the beveled edge is positioned along a side surface of the first jaw that faces the second jaw, and wherein the beveled edge has an angle between 52 degrees and 58 degrees relative to the side surface of the first jaw.

14. The wire stripper of claim 12, wherein the first jaw and the second jaw have a first hardness, wherein the beveled edge has a second hardness, and wherein the second hardness is different than the first hardness.

15. The wire stripper of claim 14, wherein the second hardness is greater than 62 HRC.

16. A hand tool comprising:
a first jaw, the first jaw comprising:
a first tip portion;
a first beveled edge; and
a first plurality of apertures positioned between the first beveled edge and the first tip portion;
a second jaw, the second jaw comprising:
a second tip portion;
a second beveled edge; and
a second plurality of apertures positioned between the second beveled edge and the second tip portion;
a pivot pin coupling the first jaw to the second jaw for movement of the first jaw and the second jaw about a pivot axis;
a longitudinal plane extending perpendicular to the pivot axis;
a first handle is coupled to the first jaw; and
a second handle is coupled to the second jaw; and
a first cutting recess defined in a rear upper portion of the first jaw, the first cutting recess facing away from the pivot axis.

17. The hand tool of claim 16, further comprising a second cutting recess defined in a rear lower portion the second jaw, the second cutting recess facing away from the pivot axis.

18. The hand tool of claim 16, wherein the first cutting recess comprises a cutting edge that extends at an angle relative to the longitudinal plane.

19. The hand tool of claim 18, wherein the angle is between 77 and 83 degrees.

20. The hand tool of claim 16, wherein the first beveled edge extends along a length of the first jaw and is positioned on a first side of the longitudinal plane, and wherein the second beveled edge extends along a length of the second jaw and is positioned on a second side of the longitudinal plane.
